(19) United States
(12) Patent Application Publication
(10) Pub. No.: US 2002/0198838 A1
(43) Pub. Date: Dec. 26, 2002

(54) Self-service terminal

(75) Inventors: Kenneth A. Nicoll, Dundee (GB); Mark M. Grossi, Dundee (GB); Grant C. Paton, Dundee (GB)

Correspondence Address: Michael Chan, Intellectual Property Section, Law Department, NCR Corporation, 1700 South Patterson Blvd., Dayton, OH, 45479-0001, US

(73) Assignee: NCR Corporation

(21) Appl. No.: 09/891,920

(22) Filed: Jun. 26, 2001

(51) Int. Cl. G06F 17/60; G06F 7/08

(52) U.S. Cl. 705/43; 235/381

(57) ABSTRACT

A self-service terminal (10) is provided, which includes a plurality of media dispense modules (20, 22) and media pick mechanisms (30, 48). At least one module (20) is associated with a vacuum pick mechanism (30), while at least one other module (22) is associated with a friction pick mechanism (48). In a preferred embodiment of the invention, the friction pick module (22) includes a plurality of media storage locations (42), each of which is associated with a friction pick mechanism (48). The modules may also be removable and interchangeable. Also provided is an SST with at least one friction pick media module including a plurality of media storage locations and friction pick mechanisms; and a friction pick media module per se.

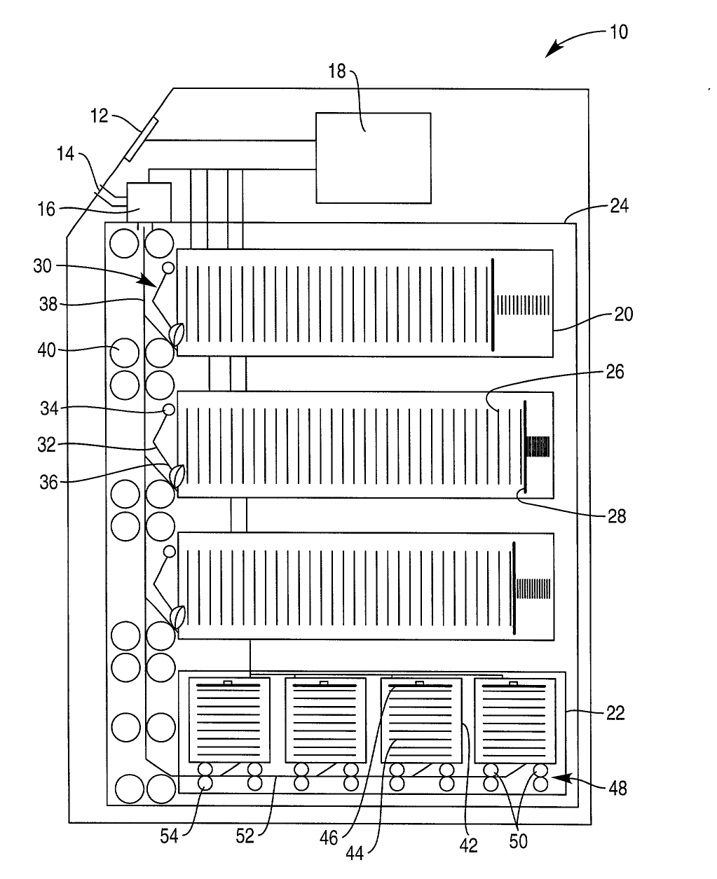

### BACKGROUND OF THE INVENTION

The present invention relates to a self-service terminal (SST), such as an automated teller machine (ATM), capable of dispensing multiple media types through multiple media pick and dispense mechanisms. The invention further relates to a media module for use in such an SST.

Self-service terminals (SSTs), such as automated teller machines (ATMs), are frequently used to dispense a range of media: for example, banknotes, tickets, vouchers, telephone cards, and the like. A dispensing SST typically includes a media module for each media type to be dispensed. Media is removed from a module by a media pick mechanism, passed along a media transport path, and presented to the user through a dispense slot. Media pick mechanisms are generally of one of two types: vacuum pick mechanisms, where individual media items are removed from a stack by means of suction cups, passed to the transport path, and released from the suction cups; and friction pick mechanisms, where media is typically removed by means of a rotating wheel, which urges the media into the transport path.

Each type of pick mechanism has its own strengths and weaknesses, and both are widely used; in general, however, vacuum pick is more suited to thinner media such as banknotes, while friction pick is more suited to thicker media such as card or plastic. Conventionally, an SST will employ only one type of pick mechanism.

A conventional ATM is usually provided with two, three or four media modules, or cassettes, limiting the ATM to dispensing a maximum of four types of media. While this is generally sufficient, there may be situations where it is desirable to dispense multiple media types: for example, several denominations of banknotes, and several denomination of ready-charged cashless smart cards; or at airport terminals where ATMs are desired to dispense banknotes of a number of different currencies. In these situations, it is necessary to either limit the types of media available, or to provide specially-manufactured ATMs with a nonstandard number of media cassettes.

Furthermore, the “industry standard” of conventional ATMs were originally designed with the function of dispensing banknotes only in mind. Thus, current standard media cassettes are of a size suitable for holding a large number of high turnover media; around 2,500 banknotes. However, when lower turnover media is dispensed, the ATM operator will generally prefer not to load this many media items into the ATM at one time; therefore the cassette will be filled only half or quarter full. This means that there is a large amount of wasted space in the ATM.

Thus, there is a need for SSTs which are able to dispense many media types, and/or which can use cassettes containing fewer media items without wasting space.

### SUMMARY OF THE INVENTION

According to a first aspect of the present invention there is provided a self-service terminal (SST) comprising a plurality of media dispensing modules, each module being operatively associated with a pick mechanism for picking media from the module and transferring picked media to a media dispense path, at least one module being associated with a vacuum pick mechanism, and at least one other module being associated with a friction pick mechanism.

The present invention thus provides an SST which is capable of dispensing media using either a vacuum pick or a friction pick mechanism, depending on which mechanism is most appropriate for the type of media to be dispensed.

Preferably the modules are of substantially similar shape and dimensions; preferably also the modules are removable and interchangeable. Preferably also the modules are of dimensions consistent with those of conventional media modules of SSTs. This enables the modules to be assembled in an SST to provide whichever combination of friction pick and vacuum pick modules is desired.

Preferably the friction pick mechanism is contained within or otherwise integral with the friction pick module. In a preferred embodiment, this enables the module to be inserted in a conventional “vacuum pick” SST and for media to be picked from the module without substantial modifications being made to the SST.

Preferably the friction pick module comprises a plurality of friction pick units, each unit comprising a media storage location and a friction pick mechanism. Preferably also all the friction pick units of a module share a common media exit path within the module leading to the SST media dispense path. A single SST media module may thus enable the SST to dispense a number of different types of media. Preferably the friction pick module comprises two, three or four friction pick units. Each individual unit may contain significantly fewer media items than a conventional module; the friction pick module may conveniently therefore be used for dispensing types of media for which there is less demand or turnover than media dispensed from conventional modules.

Preferably the vacuum pick mechanism is arranged to pick media from a front or a rear face of the vacuum pick module. This enables several modules to be stacked vertically in a limited space. Preferably the media dispense path is disposed adjacent the vacuum pick mechanism.

Preferably each friction pick mechanism is arranged to pick media from a lower, upper, or side face of the associated media storage location within the module. Preferably the mechanism is arranged to pick media from a lower face of the location. This enables multiple friction pick units to be arranged within the module without interfering with one another: for example, all the units will have media picked from a lower face, and passed along a single path to the SST media dispense path, which may lie at the front of the module.

Preferably, in use, each module contains a different type of media. In those embodiments in which the friction pick module includes a plurality of friction pick units, preferably each unit, in use, also contains a different type of media.

Two or more of the modules may be provided in use with different functions: for example, while the vacuum pick module may be used to dispense banknotes, the friction pick module may be combined with a printing means, and dispense vouchers, tickets or the like prepared and printed on demand. Other functionalities may instead or in addition be provided: for example, reading/writing of magnetic recording media such as magnetic stripes on plastic cards; reading/writing of smart cards; and the like.

According to a second aspect of the present invention, there is provided a self-service terminal (SST) comprising one or more media dispensing modules, at least one module including a plurality of media storage locations and a friction pick mechanism operatively associated with each media storage location for picking media from the storage location and transferring picked media to a media dispense path, the modules being removable from the SST.

According to a further aspect of the present invention, there is provided a media dispensing module, for use in a self-service terminal, the module comprising a plurality of media storage locations, and a friction pick mechanism associated with each media storage location for picking media from the location and transferring picked media to a media dispense path for transporting media from the module.

According to a still further aspect of the present invention, there is provided a method of dispensing media from a self-service terminal (SST), the method comprising the steps of:

selectively removing media from one of a plurality of media storage locations disposed within a media dispense module; and

presenting removed media to a user.

### BRIEF DESCRIPTION OF THE DRAWINGS

These and other aspects of the present invention will now be described by way of example only and with reference to the accompanying drawing which shows a schematic diagram of a self-service terminal (SST) in accordance with one embodiment of the present invention.

### DETAILED DESCRIPTION

The FIGURE shows a sketch of a self-service terminal (SST) 10 in accordance with one embodiment of the present invention The SST 10 includes a user interface 12, in the form of a touch-sensitive display screen, for interacting with and taking commands from a user, and a media dispensing slot 14. The media dispensing slot 14 accepts media to be dispensed from a media collator 16, which assembles media into a bundle before passing the bundle to the dispense slot 14. Both the user interface 12 and the media collator 16 are connected to a transaction processor 18, which controls the flow of a transaction, and executes commands given by a user. The transaction processor 18 is also connected to a number of media modules 20, 22 contained within a reinforced safe 24.

The media modules 20, 22 are of two different types. The first type is a vacuum pick module 20. Each of these is loaded with a large number of media items 26, which are urged against the front face of the module 20 by means of a spring-urged plate 28. At the front of the module 20 is disposed a vacuum pick mechanism 30, comprised of an arm 32 mounted on a pivot 34, with a pneumatic suction cup 36 at the free end of the arm 32. The movement and supply of air to the pick mechanism 30 is controlled by the transaction processor 18.

Extending upwardly within the front portion of the safe 24 is a media dispense path 38, along which media to be dispensed is driven by paired rollers 40 into the media collator 16.

When media 26 is to be dispensed from a vacuum pick module 20, the arm 32 of the pick mechanism pivots to bring the suction cup 36 into contact with the front most media item in the module 20. Actuation of the air supply holds the media securely against the cup 36. The arm 32 then pivots away from the module 20 to bring the media into contact with the media dispense path 38. The air supply is cut off, which releases the media, which can then be moved along the dispense path 38 into the media collator 16.

The second type of media module is a friction pick module 22. This module includes four media containers 42, each of which is loaded with media 44 which is urged downward by a spring-urged plate 46. Adjacent the lower face of each container 42 is a friction pick mechanism 48, which comprises a pair of wheels 50 in contact with the lowermost media item. Each friction pick mechanism leads into a common media transport path 52, within the module 22, which in turn feeds media into the main media dispense path 38. Media is driven along the transport path 52 by rotation of wheels 54.

Rotation of the wheels 50 of the friction pick mechanism 48 engages the lowest media item and urges it forward into the media transport path 52, from where it is passed to the media dispensing path 38.

Each of the media containers 42 and friction pick mechanisms 48 is controlled separately by the transaction processor 18 so that a specific media type may be selectively dispensed.

Each of the media modules 20, 22 may be removed from the SST 10 for refilling or servicing, and can be replaced in any module position of the SST 10. All that is necessary to alter a vacuum pick location to a friction pick location is to update the software executed by the transaction processor 18, so that the SST 10 “knows” which type of module is present.

The vacuum pick mechanism 30 may be removed when a friction pick module 22 is used, but this is not essential.

The combination of modules which is used will depend on the number and types of media it is desired to dispense, and the turnover rate of the media types.

It can be seen that the present invention therefore provides a self-service terminal which is capable of combining friction pick and vacuum pick mechanisms for different media types; and of dispensing many different types of media from a single relatively compact SST.

In other embodiments of the invention a media dispensing module for containing multiple media types may be provided with vacuum pick mechanisms, adapted for connection to an existing SST pneumatic control system.

What is claimed is:

1. A self-service terminal comprising:
a plurality of media dispensing modules, each module being operatively associated with a pick mechanism for picking media from the module and transferring picked media to a media dispense path, at least one module being associated with a vacuum pick mechanism, at least one other module being associated with a friction pick mechanism.

2. A self-service terminal of claim 1, wherein the modules are removable and interchangeable.

3. A self-service terminal of claim 1, wherein the friction pick mechanism is contained within the friction pick module.

4. A self-service terminal of claim 3, wherein the friction pick module comprises a plurality of friction pick units, each unit including a media storage location and a friction pick mechanism.

5. A self-service terminal of claim 4, wherein the friction pick units share a common media exit path within the module and leading to the media dispense path.

6. A self-service terminal comprising:
means defining a media dispense path;
a vacuum pick mechanism;
a friction pick mechanism; and
a plurality of media dispensing modules, each media dispensing module being operatively associated with a pick mechanism for picking media from the module and transferring picked media to the media dispense path, at least one media dispensing module being associated with the vacuum pick mechanism and at least one other media dispensing module being associated with the friction pick mechanism.

7. A self-service terminal of claim 6, wherein the media dispensing modules are removable and interchangeable.

8. A self-service terminal of claim 6, wherein the friction pick mechanism is contained within the media dispensing module associated with the friction pick mechanism.

9. A self-service terminal of claim 8, wherein the media dispensing module associated with the friction pick mechanism comprises a plurality of friction pick units, each unit including a media storage location and a friction pick mechanism.

10. A self-service terminal of claim 9, wherein the friction pick units share a common media exit path which is within the media dispensing module and leads to the media dispense path.

11. A self-service terminal comprising:
means defining a media dispense path; and
a number of removable media dispensing modules, at least one media dispensing module including a plurality of media storage locations and a friction pick mechanism operatively associated with each media storage location for picking media from the media storage location and transferring picked media to the media dispense path.

12. A media dispensing module for use in a self-service terminal, the media dispensing module comprising:
means defining a media dispense path;
a plurality of media storage locations; and
a friction pick mechanism associated with each media storage location for picking media from the media storage location and transferring picked media to the media dispense path for transporting media from the media dispensing module.

13. A media dispensing module according to claim 12, further comprising means for enabling the media dispensing module to be removable and interchangeable in a self-service terminal.

14. A method of dispensing media from a self-service terminal, the method comprising the steps of:
selectively removing media from one of a plurality of media storage locations disposed within a media dispense module; and
presenting removed media to a user.
